(19) United States
(12) Patent Application Publication
(10) Pub. No.: US 2025/0392246 A1
(43) Pub. Date: Dec. 25, 2025

(54) Three-Phase Machine, Hydraulic Pump and a Method for the Operation Thereof

(71) Applicant: KNORR-BREMSE Systeme fuer Nutzfahrzeuge GmbH, Muenchen (DE)

(72) Inventors: Zeger BONTINCK, Muehlacker (DE); Richard BARABASI, Budapest (HU); Dieter BARTHEL, Rodenbach (DE)

(21) Appl. No.: 19/246,818

(22) Filed: Jun. 24, 2025

(30) Foreign Application Priority Data
Jun. 24, 2024 (DE) 10 2024 117 700.4

(51) Int. Cl. H02P 29/62; F15B 15/18

(52) U.S. Cl. CPC H02P 29/62; F15B 15/18; H02P 2207/05

(57) ABSTRACT

A three-phase machine is disclosed, which runs at least partially in a fluid and has a stator with at least three coils and a rotor with at least one magnet. The rotor is enclosed by the at least three coils in a cross-sectional plane perpendicular to its axis of rotation. The three-phase machine includes a control device, which is configured to energize the three coils selectively with three alternating currents; to initiate a working mode, in which three alternating currents generate a torque on the rotor about the axis of rotation; and to initiate a heating mode, in which the three alternating currents generate an increased power loss in comparison with the working mode due to a more rapid polarity change in at least one of the three alternating currents.

### CROSS REFERENCE TO RELATED APPLICATION

This application claims priority under 35 U.S.C. § 119 from German Patent Application No. 10 2024 117700.4, filed Jun. 24, 2024, the entire disclosure of which is herein expressly incorporated by reference.

### BACKGROUND AND SUMMARY

The present invention relates to a three-phase machine, to a hydraulic pump and to a method for operating the three-phase machine, and in particular to a heating function for electric motors by using iron losses or hysteresis losses and/or ohmic losses during the excitation of the coils in the electric motor, or generally in a three-phase machine.

The self-heating of e-motors is primarily brought about by the ohmic losses in the copper parts (for example coils, cage, . . . ). This heating is generally undesired since the energy is used only inefficiently and it may lead to overheating of the e-motor. In some applications, for example e-motors that are operated in oil/hydraulic liquid or under particular ambient conditions (for example at low temperatures), this thermal effect may however be used in order to heat the hydraulic liquid in the motor. The heating of the coils causes the hydraulic liquid to be heated so that its viscosity is reduced, which in turn leads to lower friction. The motor therefore needs less torque in order to overcome this friction. Such a motor is described, for example, in WO 2020/173755 A1. In order to remain capable of functioning even at low temperatures, in such applications the surface of the rotor is normally shaped so as to optimally reduce the friction with the liquid. This, however, leads to more complex toolmaking for the rotor sheets.

The heating effect is therefore very expedient but nevertheless has disadvantages. For this reason, the ohmic losses are normally kept as low as possible in the motor design in order to reduce the continual heating of e-motors and thereby to increase the efficiency of the motor. This is achieved by keeping the internal resistance, for example of the coils, as low as possible.

Unfortunately, this design option reduces the positive influence of the ohmic losses during the self-heating at low temperatures. There is therefore a need for novel motor designs that offer a compromise between efficient heating and the lowest possible losses after the heating.

At least some of the afore-mentioned problems are solved by a three-phase machine, by a hydraulic pump, by a vehicle system, by a vehicle, by a method, and by a computer-readable storage medium, in accordance with the independent claims. The dependent claims define further advantageous embodiments of the subject matter of the independent claims.

The present invention relates to a three-phase machine, which runs at least partially in a fluid and has a stator with at least three coils and a rotor with at least one magnet. The rotor is enclosed by the at least three coils in a cross-sectional plane perpendicular to its axis of rotation. The three-phase machine furthermore comprises a control device, which is configured to:
energize the three coils selectively with three alternating currents,
initiate a working mode, in which three alternating currents generate a torque on the rotor about the axis of rotation,
initiate a heating mode, in which the three alternating currents generate an increased power loss in comparison with the working mode due to a more rapid polarity change in at least one of the three alternating currents.

It is to be understood that a separate alternating current may flow through each of the three coils, the alternating currents being controllable by the control device in respect of phase, period and amplitude and together forming a power current consisting of three phases. The magnetic fields generated by the coils are superimposed to form a rotating magnetic field, which drives the rotational movement of the rotor (in the working mode). It is furthermore to be understood that the working mode and the heating mode may also be superimposed since the individual alternating currents may be superimposed, so that, for example, heating may take place before moving off (when stationary) and final heating to an optimum operating temperature may also take place while travelling.

Forces may also act on the rotor, or the magnet, in the heating mode, although the currents may be selected so that the turning forces fully cancel one another out. Forces may, however, act in the radial direction of the magnet or in the axial direction of the magnetic flux in the rotor (for example of the magnet). These (radial) forces do not generate a torque, but they do generate heat because of the polarity reversal.

According to some exemplary embodiments, the three-phase machine is a radial-flux machine, in which the magnetic flux runs in the radial direction through the coils.

Optionally, the control device is configured to operate the three-phase machine alternatively in the working mode or in the heating mode, no torque being generated in the heating mode. The alternating current generates only a power loss. In particular, the heating mode may also be carried out only before moving off. Thus, according to some exemplary embodiments, in a vehicle that has the three-phase machine a temperature of the fluid may be initially measured when switching on the ignition and, if heating of the corresponding unit (for example a hydraulic pump or power steering) is recommended, the control device may first start the heating mode on the basis of the measured temperature. When an operating temperature is reached, the driver may be informed so that a transition may then be made to the working mode, i.e. the vehicle may be put into operation.

Optionally, the three-phase machine can be connected to a source of a DC voltage, wherein the control device is further configured to apply the DC voltage with alternating polarities to the at least three coils and to vary (increase or reduce) an edge steepness during the change of the polarity in the heating mode in comparison with the working mode.

Optionally, the control device is configured to apply the DC voltage with the alternating polarities to the at least three coils by a pulse-width modulation (duty cycle between voltage and no voltage) of controlled amplitudes. Three different voltages are in this case applied. By these three voltages, a current vector may be generated without generating a torque.

Three-phase machines usually operate with three-phase alternating currents, which are offset in phase by 120° with respect to one another. The voltage profiles have, for example, a trapezoidal shape and alternate between a positive polarity and a negative polarity, the DC current being applied with the positive pole during one phase and being applied with a time offset thereto in a further phase of the DC current with the negative pole to another coil. The remaining coil is idle during this time, in which for example no voltage is applied to the coil (so-called floating state). The heating power can be adjusted by lengthening or shortening transitions from the positive polarity to the negative polarity, or vice versa. The transition phases therefore have a greater or lesser edge steepness. The edge steepness leads to more rapid reversal of magnetization in the magnetic materials of the three-phase machine, which in turn leads to higher losses and therefore generates the desired heat.

According to some exemplary embodiments, the instant of the zero crossing may remain constant and the edge only needs to be rotated. In other words, the on-phases as a whole do not need to be shifted, but only need to be lengthened symmetrically on both sides. The off-phases, in which no voltage is applied, therefore become shorter, which in turn compels a more rapid polarity reversal.

Optionally, the three alternating currents can be combined into a d-current and a q-current in a coordinate system that moves with the rotor. The d-current generates a magnetic flux that does not generate a torque in the rotor, and may therefore also be regarded or referred to as a heating current. The q-current generates a magnetic flux that does cause a torque in the rotor, and may therefore also be regarded or referred to as a working current (three-phase current). The control device may then be configured to generate (only) the d-current (heating current) in the heating mode. It is to be understood that the q-current and the d-current may be composed of various partial currents through the individual coils.

According to some exemplary embodiments, the heating power may therefore be controlled by controlling the d-current, while the torque and therefore the turning power of the three-phase machine may be controlled by controlling the q-current.

Optionally, the stator and/or the rotor has a motor lamination consisting of one of the following materials: carbon steel, stainless steel, manganese steel, silicon steel, M12 or M15 silicon steel sheets. Thus, silicon steel sheets of the lowest quality may be used, with concomitantly increased hysteresis losses. The materials used may have somewhat unfavorable electromagnetic properties in favor of low costs (for example M12 or M15 silicon steel sheets) or in favor of improved mechanical properties (for example carbon steels or stainless steels).

Optionally, the stator and/or the rotor comprises a motor lamination that has short-circuits between sheets of the motor lamination in the axial direction at predetermined locations, in order to increase the eddy current losses in a controlled manner. The predetermined locations may be determined so that eddy currents can develop efficiently (i.e. a maximally uniform and closed flow of current can result).

According to some exemplary embodiments, therefore, although materials having high hysteresis losses are employed, materials having low ohmic losses (for example copper) are used for the electrical lines (for example in the coils).

Optionally, the control device comprises a cooling device with thermal bridges, which dissipate the generated heat to the interior. For example, the control device may comprise a printed circuit board that is fitted with active electronic components (for example power transistors), which in their turn generate a considerable amount of heat during operation. According to some exemplary embodiments, this heat may also be used to heat up the fluid, for which purpose the thermal bridges may for example be used.

Optionally, the three-phase machine is a permanent-magnet synchronous motor (PMSM), for example with field-oriented control. In this motor, permanent magnets are used as field exciters. According to further exemplary embodiments, however, the three-phase machine may also be an asynchronous motor, reluctance motor, BLDC (brushless DC motor), etc.

Some exemplary embodiments also relate to a hydraulic pump for a hydraulic liquid, the pump having one of the three-phase machines described above. The interior of the three-phase machine contains a part of the hydraulic liquid. Furthermore, gaskets are configured to seal the interior having the hydraulic liquid from the control device and/or from other components. In particular, the three-phase machine may be immersed fully or partially in the hydraulic liquid.

The hydraulic pump may for example be used for various assistance units of a vehicle, for example of a truck or of another commercial vehicle. In particular, some exemplary embodiments also relate to power steering having the hydraulic pump.

Some exemplary embodiments also relate to a vehicle system having the hydraulic pump described above and/or having the three-phase machine. The vehicle system may be at least one of the following: power steering, a brake system, a system with a ball-screw drive, a clutch actuator with a ball-screw drive.

Some exemplary embodiments also relate to a vehicle, in particular a truck, having a three-phase machine and/or power steering and/or a vehicle system as have been described above.

Some exemplary embodiments also relate to a method for driving a three-phase machine. The method comprises:
selectively energizing three coils with three alternating currents;
in a working mode, generating a torque on the rotor by the three alternating currents (i.e. by a rotating magnetic field generated by the alternating currents); and
initiating a heating mode, in which the three alternating currents generate an increased power loss in comparison with the working mode due to a more rapid polarity change in at least one of the three alternating currents.

For example, an increased amplitude may be generated in at least one of the three alternating currents in the heating mode in comparison with the working mode.

It is to be understood that all the above-described functions of the control device may be configured as further optional method steps. Furthermore, it is to be understood that the order in which they are mentioned is not necessarily an order in which the method steps are carried out. The steps may also be carried out in a different order, or only some of the method steps are carried out.

This method, or at least parts of this method, may likewise be implemented or stored in the form of instructions in software or on a computer program product, stored instructions being capable of carrying out the steps according to the method when the method runs on a processor. The present invention therefore likewise relates to a computer program product having software code (software instructions) stored thereon, which is configured to carry out one of the methods mentioned above when the software code is executed by a processing unit. The processing unit may be any form of computer or control unit that has a corresponding microprocessor which can execute a software code. Some exemplary embodiments therefore also relate to a computer-readable storage medium having instructions stored thereon, which are configured to make the above-described control device of the three-phase machine carry out the method described above when the instructions are carried out on a data processing unit.

Advantageous aspects of some exemplary embodiments may be summarized as follows. Some exemplary embodiments solve at least some of the aforementioned technical problems by using iron losses or hysteresis losses in sheets of the motor lamination as a heat source, so as to bring the fluid as rapidly as possible to operating temperature. Rapid switching of the sign of an applied DC current in this case leads to a rapid polarity change (from “+” polarity to “−” polarity and vice versa). This in turn causes rapid reversals of magnetization and therefore the desired hysteresis loss. The usable heat loss depends on the speed of the pole reversal. According to some exemplary embodiments, hysteresis losses are therefore deliberately increased while ohmic losses (due to the ohmic resistance) are kept low, since they likewise lead to superfluous heat losses during normal operation.

For this purpose, some exemplary embodiments use an intelligent control technology during the starting of the vehicle or of the system (for example a hydraulic unit such as a pump) so as to bring the viscosity of the fluid into a standard range in advance.

Exemplary embodiments of the present invention will be understood more clearly from the following detailed description and the accompanying drawings of the various exemplary embodiments, although they should not be interpreted as restricting the disclosure to the specific embodiments but merely serve for explanation and understanding.

### BRIEF DESCRIPTION OF THE DRAWINGS

FIG. 1A shows a three-phase machine according to one exemplary embodiment of the present invention.

FIG. 1B illustrates the driving of the coils according to some exemplary embodiments.

FIG. 2 shows a cross-sectional view through the axis of rotation of the three-phase machine and the forces acting, according to some exemplary embodiments.

FIG. 3 shows a voltage profile of all three phases.

FIG. 4 shows a schematic flowchart of a method for driving the three-phase machine according to some exemplary embodiments.

### DETAILED DESCRIPTION OF THE DRAWINGS

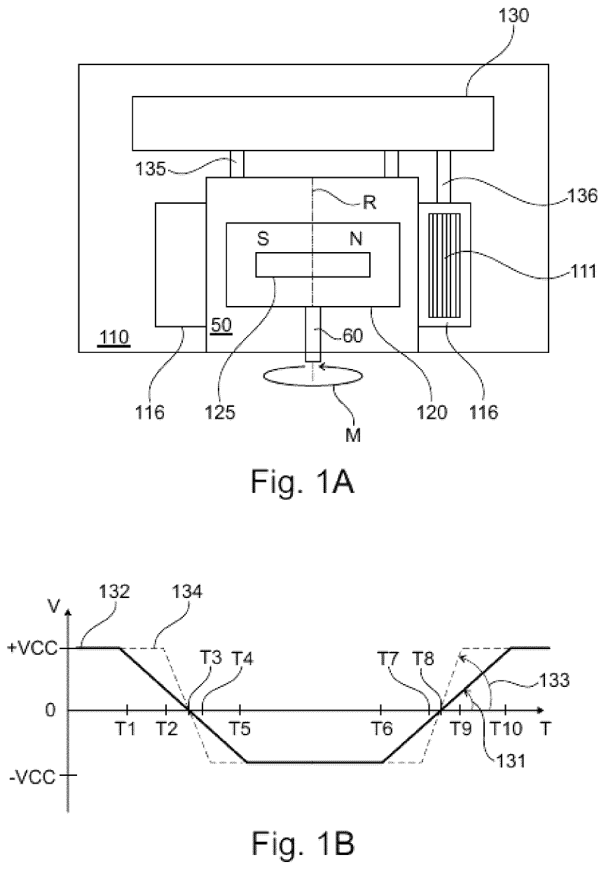

FIG. 1A shows a three-phase machine according to one exemplary embodiment of the present invention. The three-phase machine comprises a stator 110, a rotor 120 and a control device 130. The stator 110 comprises at least three coils 111, which are typically embedded in a motor lamination 116. The stator 110 may be connected rigidly to a housing of the three-phase machine. The rotor 120 comprises at least one magnet 125, and couples to a shaft 60 with which the rotor 120 provides a torque M during operation (for example for a pump or servo actuator). The rotor 120 is mounted in an interior 50 of the three-phase machine so that it can rotate about an axis of rotation R of the shaft 60. There may be a fluid in the interior 50, for example oil or another liquid, which has a temperature-dependent viscosity.

In a cross-sectional plane perpendicular to the axis of rotation R, the at least three coils 111 are arranged in a circle around the rotor 120, for example with angular separations of 120° or 60° (for example if there are six coils). According to further exemplary embodiments, the three-phase machine comprises at least three busbars 136 between the control device 130 and the at least three coils 111, in order to energize the coils 111 selectively with three alternating currents. The control device 130 is configured to control the three alternating currents. Via a plug connector on the housing, the three-phase machine may be connected to a DC voltage source. The DC voltage may be supplied to the control device and converted there by using switches (for example power transistors) into the three desired alternating currents, which are then supplied via the busbars 136 to the coils.

According to further exemplary embodiments, the three-phase machine comprises thermal bridges 135 between the control device 130 and the interior 50, which provide thermal coupling between heat-generating components of the control device 130 (for example the power transistors) and the interior 50 so as to bring about a flow of heat from the control device 130 to the fluid inside the stator 110. This heat therefore also contributes to the rapid heating of the fluid.

The exemplary motor lamination 116, in which the at least three coils 111 are embedded as an encapsulation, also forms the coil cores and may have laminated metal sheets (for example of iron or steel). The constant reversals of magnetization during operation are affected by losses, and are also referred to as iron losses. According to some exemplary embodiments, iron or steel need not necessarily be employed for the motor lamination 116, and other (ferro-) magnetic materials may be used. Advantageously, materials that have enough hysteresis losses to controllably bring about sufficient generation of heat are employed. According to some exemplary embodiments, the hysteresis losses should purposely not be minimized, in order to generate enough heat.

FIG. 1B illustrates an exemplary embodiment of the driving of the three coils 111 by the control device 130. Specifically, it shows a voltage profile V as a function of time T, this being shown by way of example only for one of the three coils 111. The voltage V changes between a positive supply voltage +VCC and the corresponding negative supply voltage −VCC, in which case the supply voltages +/−VCC may be two poles of a DC voltage source, or are provided by an optional voltage transformer.

A first voltage profile 132 (solid line) represents the normal working mode. Until a first instant T1, the positive polarity (+VCC) is applied to the coil 111. At the instant T1, a connection to +VCC is separated and the voltage falls continuously. At the fifth instant T5, the negative polarity (−VCC) is applied to the coil 111. This polarity is maintained until the sixth instant T6, at which separation from the voltage supply again takes place. At the tenth instant T10, the positive polarity +VCC is again applied, the voltage increasing successively between times T6 and T10. The application and separation of the polarities, +VCC, −VCC, is according to some exemplary embodiments controlled by the control device 130. An edge steepness 131 between the two polarities, positive and negative, does not need to be driven by the control device 130 but is adjusted automatically. The corresponding contacts may during this time be open (“floating”) so that the electrical potential will successively vary. The edge steepness 131 is, however, determined by the duration between the tenth instant T10 and the sixth instant T6. A trapezoidal alternating current therefore results for the exemplary coil 111.

A second voltage profile 134 (dashed line) illustrates an exemplary embodiment of the one coil 111 being driven by the control device 130 in the heating mode. In the heating mode, the control device 130 controls the alternating currents in such a way that the coils generate an increased power loss in comparison with the working mode (voltage profile 132). In the exemplary embodiment shown, the increased power loss is brought about by a more rapid polarity change in at least one or all three of the alternating currents. In the heating mode, the polarity change takes place between a second instant T2, until which the positive polarity +VCC is maintained, and a fourth instant T4, at which the negative polarity −VCC is applied. The second instant T2 and the fourth instant T4 may be selected arbitrarily, the more rapid polarity change being achieved when the following are satisfied: T2>T1 and T4<T5.

The same applies for the polarity change from the negative polarity to the positive polarity, for example with the negative polarity remaining applied in the heating mode until a seventh instant T7 and the positive polarity being applied at a ninth instant T9. The seventh instant T7 and the ninth instant T9 may also be selected arbitrarily, the more rapid polarity change being achieved by the following being satisfied: T7>T6 and T9<T10. Consequently, an edge steepness 133 during the polarity change is increased in the heating mode in comparison with the working mode.

According to some exemplary embodiments, the instant of the zero crossing may remain constant as a function of time during the activation of the heating mode, or within the heating mode. In FIG. 1B, the first zero crossing for the first voltage profile 132 (working mode) as well as for the second voltage profile 134 (heating mode) occurs at a third instant T3 (the voltage value is zero there, or corresponds to the average value of the positive supply voltage and the negative supply voltage). The second zero crossing, from the negative polarity to the positive polarity, takes place at the eighth instant T8, which in turn may be the same both in the working mode and in the heating mode (i.e. it may take place at the same time). During the transition from the working mode to the heating mode, the edge steepness 131, 133 may therefore merely be rotated so that the periods (the durations) in the positive polarity +VCC remain equal to the periods with negative polarity −VCC, i.e. the ratio of the two periods does not have to vary even though the individual durations vary.

This, however, need not necessarily be the case. According to some exemplary embodiments, the control device 130 may initiate the polarity change arbitrarily, for example in order to cause optimum/maximum generation of heat without initiating a rotational movement of the rotor 120.

The control device 130 may further be configured to bring about a continuous transition from the working mode to the heating mode, and vice versa. If there is an edge steepness 131 in the working mode (see FIG. 1B), this angle may be increased continuously in the heating mode to a new angle (edge steepness 133). In the working mode, the three alternating currents may for example be applied selectively to the at least three coils 111 in such a way that, at each instant, a positive polarity is applied to precisely one coil and a negative polarity is applied to precisely one other coil. The durations of the application of the positive/negative polarity may correspond to an angular movement of the rotor 120 through 120° about the axis of rotation R. On the other hand, there may be times in the heating mode when the positive (or negative) supply voltage is applied to more than one of the coils 111. Accordingly, forces may act in various directions (when for example two coils at particular times have an attractive effect on the rotor 120, rather than just one coil). This overlap also leads to losses since the rotating magnetic field is weakened and radial (loss) forces act, so that heat is generated.

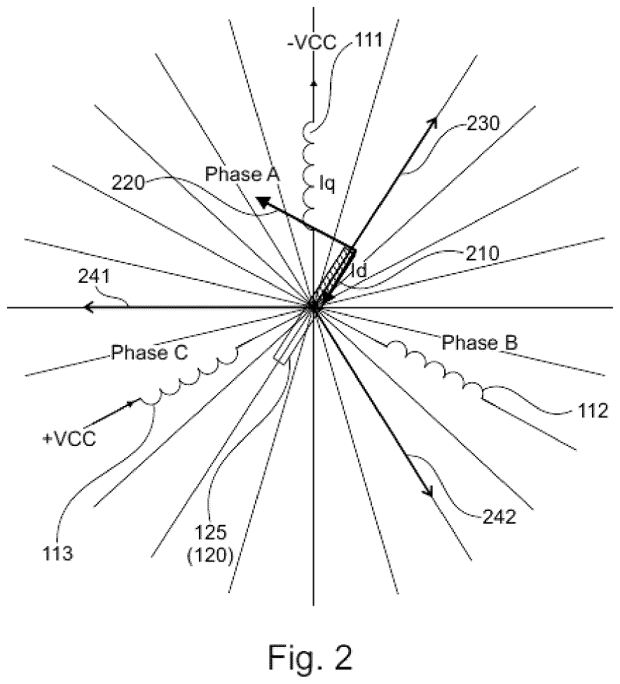

FIG. 2 shows a cross-sectional view perpendicular to the axis of rotation R, and illustrates the forces that act in order to generate the torque M with the three-phase machine. For the sake of simplicity, only the magnet 125 of the rotor 120 is represented, around which three coils 111,112, 113 are arranged at the exemplary separation of 120°. The three coils comprise a first coil 111, a second coil 112 and a third coil 113, which can be excited by three-phase power current with a phase A, a phase B and a phase C.

In the state shown, the negative polarity −VCC is applied to the first coil 111, the positive polarity +VCC is applied to the third coil, and the second 112 is voltage-free, i.e. the control device 130 leaves the potential there freely “floating” at the instant shown. The three coils 111, 112, 113 are electrically connected to one another on one side, where for example ground potential or the zero voltage (=average value of +VCC and −VCC) is applied, in which case the positive polarity +VCC and the negative polarity −VCC may be applied to those ends of the coils 111, 112, 113 that are not connected to one another.

The rotation of the rotor 120 is now brought about by the polarities being successively varied at the individual coils, so that the magnetic fields vary continually and alternating forces act on the magnet 125. In the state shown, the first coil 111 attracts for example the black pole of the magnet 125 and the third coil 113 attracts the white pole of the magnet 125. The magnet 125 is in equilibrium; it has aligned with the flux vector 230. The polarity changes lead to a rotating magnetic field, which the rotor 120 follows since the rotor 120 constantly aligns its longitudinal axis along the (rotating) magnetic flux vector 230. The flux vector 230 can correspondingly jump successively to the new flux vectors 241, 242; the magnet 125 will successively rotate accordingly. The continual polarity changes generate turning forces 220 and therefore the torque M that acts on the rotor 120, i.e. the torque that the latter can deliver. The alternating current that generates the turning forces 220 is called the q-current Iq.

In the heating mode, according to some exemplary embodiments, the same polarity, −VCC or +VCC, may however be applied to two coils simultaneously. Thus, in the position shown, the second coil 112 may be not “floating” but also at −VCC. During the polarity change, a rotating magnetic field no longer occurs. Abrupt variations may occur, although the magnet 125 cannot follow these by a rotational movement. This means that a longitudinal force 210 is generated, which makes no contribution to the rotational movement and represents an energy loss, and is ultimately converted into heat. If the currents are selected so that all the turning forces cancel out, only radial forces 210 are now generated. These forces act only in the radial direction of a polar coordinate system in FIG. 2, so that all of the energy is converted into heat. This current is also called the d-current Id.

According to some exemplary embodiments, the control device 130 may control the alternating currents so that the rotor 120 performs a vibrating angular movement within a predetermined angle range (it rotates rapidly forward and back), which leads to further heating of the fluid. According to further exemplary embodiments, when the three-phase machine is at rest, alternating d-currents Id are generated which lead only to longitudinal forces 210 (along the longitudinal axis of the magnet 125) but do not generate a rotational movement. In both cases, a rapid pole reversal may take place, which leads to hysteresis losses and therefore to heating of the motor, without a continual torque (having a particular sign) being generated.

At the transition to the working mode, the q-current Iq is then generated, which generates a torque in the rotor 120. The d-current Id may be switched off immediately, although this is not essential. The lossy d-current Id may be switched off only when the three-phase machine has reached its operating temperature.

According to some exemplary embodiments, the three currents through the three coils 111, 112, 113 may thus be selected in such a way that no q-current Iq is generated in the heating mode, but instead a d-current Id that is as high and rapidly variable as possible is generated, while in the working mode a large q-current Iq is generated and the d-current Id is avoided as far as possible. In this way, a maximum active power may be ensured by the three-phase machine for a predefined current, as before.

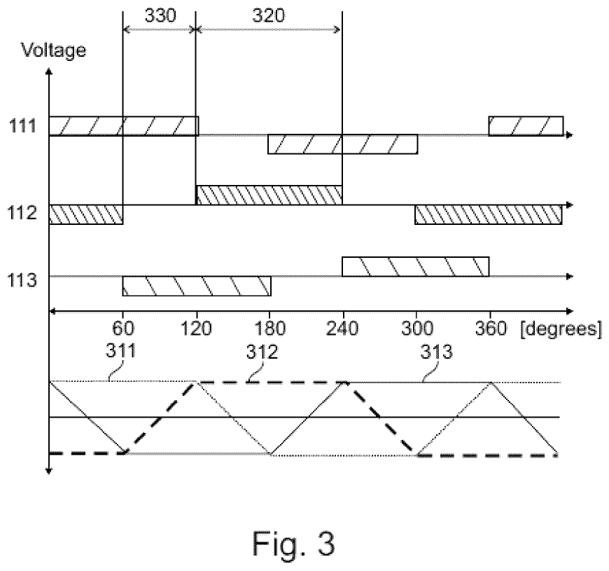

FIG. 3 shows the switching of the DC voltages at the different coils 111, 112, 113. It represents voltage profiles for the respective coils 111, 112, 113, although they are represented here as a function of the angle of the rotor 120 (or the magnet 125). In the representation, the voltage profile for the first coil 111 is first represented by way of example at the top and is initially at the positive polarity +VCC, which is switched off at an angle of 120°. At the angle 180°, the negative polarity −VCC is applied to the first coil 111 and remains there until an angle of 300°. The voltage at the first coil 111 is then again switched off and, for example, +VCC is only applied again at an angle of 360°.

The second coil 112 is driven in a similar way to this, the signals being phase-shifted by 60°, which is to say −VCC is applied first to the second coil 112, specifically until the angle 60°. Between the angles 60° and 120°, no voltage is applied. Between 120° and 240°, +VCC is applied. Between 240° and 300°, no voltage is applied, and between 300° and 330° −VCC is applied.

The third coil 113 again has the same pattern, there once more being a phase shift by 60°, which is to say −VCC is applied to the third coil 113 at an angle of 60° and remains applied there until an angle of 180°. Between 180° and 240°, no voltage is applied. Between 240° and 360°, +VCC is applied, which is then switched off again at 360°.

In the image underneath, the voltage profiles 311, 312, 313 for the individual coils 111, 112, 113 are represented superimposed; a first voltage profile 311 shows the voltage change of the first coil 111, a second voltage profile 312 shows the voltage change of the second coil 112, a third voltage profile 313 shows the voltage change of the third coil 113. Linear edges are respectively formed between the positive polarity +VCC and the negative polarity −VCC. No voltage is actively applied there but the potential applied there varies by itself in the circuit, although this does not necessarily take place linearly.

The effect of the phase shift by 60° is that in principle, at each instant, a positive voltage (+VCC) is applied to precisely one of the three coils 111, 112, 113 and the negative voltage (−VCC) is applied to one of the three coils 111, 112, 113. No defined voltage is coupled to the respectively remaining coil.

According to some exemplary embodiments, the control device 130 deliberately breaks this symmetry. For example, the control device 130 may for this purpose deliberately vary an activation duration 320 of the coils 111, 112, 113, i.e. the times when +VCC or −VCC is applied there. The activation duration may, for example, be increased or reduced continuously. Similarly, the off-duration 330 (when no potential is applied to the coils) may be reduced continuously. The control device 130 therefore controls the edge steepness during the polarity change, which occurs more rapidly (in less than 60° of the rotational movement). For example, the off-duration 330 may now be only 40° or 20° or 0°. If this is done for all the coils, oppositely acting forces occur, which as described above cannot then generate a (pure) turning force but act in the radial direction (in the direction of the magnet direction of the magnet 125). In order to achieve this, the control device 130 generates the d-currents Id, which according to some exemplary embodiments may be used to heat the fluid in the interior 50. In particular, the driving may take place in such a way that the rotational movement of the rotor 120 is blocked, or at most vibrations are generated.

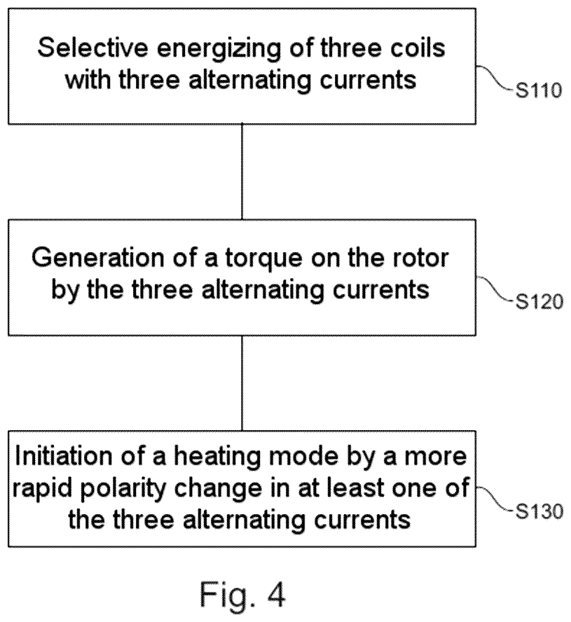

FIG. 4 shows a schematic flowchart of a method for driving the three-phase machine according to some exemplary embodiments. The method comprises the steps:
selectively energizing S110 three coils 111, 112, 113 with three alternating currents;
in a working mode, generating S120 a torque M on the rotor 120 by the three alternating currents; and
initiating S130 a heating mode, in which the three alternating currents have an increased power loss in comparison with the working mode due to a more rapid polarity change in at least one of the three alternating currents.

It is to be understood that all the above-described functions of the control device 130 may be configured as further optional method steps. Furthermore, it is to be understood that the order in which they are mentioned is not necessarily an order in which the method steps are carried out. The steps may also be carried out in a different order, or only some of the method steps are carried out.

The method may likewise be computer-implemented, i.e. it may be carried out by instructions that are stored on a storage medium and are capable of carrying out the steps of the method when it runs on a processor. The instructions typically comprise one or more instructions, which may be stored in different ways on different media in or peripherally to a control unit (having a processor), which, when they are read and carried out by the control unit, make the control unit carry out functions, functionalities and operations that are needed in order to carry out a method according to the present invention.

Advantageous aspects of some exemplary embodiments may be summarized as follows. The desired heating is achieved by rapidly changing the magnetic field. This leads to the desired iron/hysteresis losses. This heat is transmitted into the air gap (interior 50), where the fluid (for example an oil or another liquid) is heated so that its viscosity is reduced. When the control device 130 operates the three-phase machine in the heating mode, it may for this purpose correspondingly increase the edge steepness 131, 133 between the polarity changes, which is equivalent to the off-durations 330 of the coils being shortened. Through the speed that is achieved in this way for the polarity change, the losses may be adjusted, or the generation of heat by the three-phase machine may be controlled. The more rapidly the polarity changes, the more rapidly the magnetization in the materials varies, which leads to higher losses and therefore to generation of heat.

In order to reinforce this effect, according to some exemplary embodiments, materials for the motor lamination 116 are adapted. For example, it is possible to pick a material having relatively high hysteresis losses, which for conventional e-motors is regarded as being of inferior quality and is therefore avoided. According to some exemplary embodiments, for example, at least one of the following materials may be used for the motor lamination 116: carbon steel, stainless steel, manganese steel, silicon steel.

The use of sheets having relatively high losses, in combination with the rapid switching of the d-current during starting, is conducive to the rapid heating that some exemplary embodiments achieve. Some exemplary embodiments also offer the possibility of heating liquids in the interior 50 for e-motors having low ohmic resistances.

A further advantage is that some exemplary embodiments may be used wherever the air gap 50 of the motor contains a liquid whose viscosity increases at lower ambient temperatures.

Some exemplary embodiments may combine two main constituents. One resides in the design of the motor (the three-phase machine), where a material having relatively high hysteresis losses may be selected in order to increase the heating at lower temperatures. The second part relates to the control by the control device 130, which controls the heating by rapidly switching the sign of the DC current when starting up the system.

Since the rotor sheet does not require elaborate toolmaking, there is also a cost advantage for the production of the three-phase machines, or of e-motors.

Some exemplary embodiments may for example be applied in the electrical power steering, where operation is necessary at an ambient temperature of between −40° C. and +85° C. In order to increase the efficiency of the motor and to reduce the heating, at for example 85° C., the ohmic losses of an exemplary permanent-magnet synchronous motor (PMSM) are kept low. At low temperatures, the exemplary hydraulic liquid of the conventional power steering in the air gap is very viscous, which leads to a very high torque being necessary for driving the pump when starting up. Since the ohmic losses are low, the heating of these conventional hydraulics takes place only slowly. Some exemplary embodiments improve the situation significantly since heating for only a limited time is possible because of the driving.

As already explained, some exemplary embodiments use for this the hysteresis losses in the lamination of the stator 110 and/or of the rotor 120. These are achieved by rapidly switching the sign of the applied DC current (+VCC to −VCC and vice versa). These losses generate additional heat, so that the sheets of the motor lamination 116 themselves act as a heat source. The lamination 116 then releases its heat to the air gap 50. The viscosity of the hydraulic liquid is thereby reduced more rapidly, so that the motor can enter the normal operating mode more rapidly.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

50 interior
60 shaft
110 stator
111, 112, 113 at least three coils
116 motor lamination
120 rotor
125 at least one magnet
130 control device (controller, electronic control unit)
131 edge steepness (angle) in the working mode
132 voltage profile in the working mode
133 edge steepness (angle) in the heating mode
134 voltage profile in the heating mode
135 thermal bridge(s)
136 busbars
210 radial force
220 turning force
230, 241, 242 rotating magnetic flux vector (generated by Iq)
311, 312, 313 voltage profiles at the coils
320 on-duration
330 off-duration
R axis of rotation
M torque
Id d-current (heating current)
Iq q-current (working current)
+VCC positive polarity (of an applied DC voltage)
−VCC negative polarity (of an applied DC voltage)

What is claimed is:

1. A three-phase machine that runs at least partially in a fluid, the three-phase machine comprising:
a stator with at least three coils;
a rotor with at least one magnet,
wherein the rotor is enclosed by the at least three coils in a cross-sectional plane perpendicular to its axis of rotation; and
a control device operatively configured to:
energize the three coils selectively with three alternating currents,
initiate a working mode, in which the three alternating currents generate a torque on the rotor about the axis of rotation,
initiate a heating mode, in which the three alternating currents generate an increased power loss in comparison with the working mode due to a more rapid polarity change in at least one of the three alternating currents.

2. The three-phase machine according to claim 1, wherein the control device is further operatively configured to:
operate the three-phase machine alternatively in the working mode or in the heating mode, wherein no torque is generated in the heating mode.

3. The three-phase machine according to claim 1, which is connectable to a source of a DC voltage, wherein the control device is further operatively configured to:
apply the DC voltage with alternating polarities to the at least three coils and to increase an edge steepness during the change of the polarity in the heating mode in comparison with the working mode.

4. The three-phase machine according to claim 3, wherein the control device is further operatively configured to:
apply the DC voltage with the alternating polarities to the at least three coils by a pulse-width modulation of controlled amplitudes.

5. The three-phase machine according to claim 1, wherein
the three alternating currents are combinable into a d-current and a q-current in a coordinate system that moves with the rotor,
the d-current generates a magnetic flux that does not generate a torque in the rotor, and
the q-current generates a magnetic flux that does generate a torque in the rotor,
the control device being further operatively configured to generate the d-current in the heating mode.

6. The three-phase machine according to claim 1, wherein
the stator and/or the rotor has a motor lamination made of at least one of the following materials: carbon steel, stainless steel, manganese steel, silicon steel, or M12 or M15 silicon steel sheets.

7. The three-phase machine according to claim 1, wherein
the stator and/or the rotor has a motor lamination that has short-circuits between sheets of the motor lamination in the axial direction at predetermined locations, in order to increase eddy current losses in a controlled manner.

8. The three-phase machine according to claim 1, wherein
the control device comprises a cooling device with thermal bridges, which dissipate the generated heat to an interior of the machine.

9. The three-phase machine according to claim 1, wherein the machine is configured as a permanent-magnet synchronous motor.

10. A hydraulic pump for a hydraulic liquid, comprising:
a three-phase machine according to claim 1;
wherein an interior of the three-phase machine includes a part of the hydraulic liquid and has gaskets in order to seal the interior having the hydraulic liquid from the control device.

11. A vehicle system comprising a hydraulic pump according to claim 10.

12. The vehicle system according to claim 11, wherein the vehicle system is at least one of: a power steering, a brake system, a system with a ball-screw drive, or a clutch actuator with a ball-screw drive.

13. A vehicle comprising a three-phase machine according to claim 1.

14. A method for driving a three-phase machine, comprising:
selectively, for the three-phase machine, energizing three coils with three alternating currents;
in a working mode of the three-phase machine, generating a torque on a rotor by the three alternating currents; and
initiating a heating mode of the three-phase machine, in which the three alternating currents generate an increased power loss in comparison with the working mode due to a more rapid polarity change in at least one of the three alternating currents.

15. The method according to claim 14, wherein an increased amplitude is generated in at least one of the three alternating currents in the heating mode in comparison with the working mode.

16. A computer product comprising a non-transitory computer-readable storage medium having instructions stored thereon which, when the instructions are executed on a data processing unit, carry out the acts of:
selectively, for the three-phase machine, energizing three coils with three alternating currents;
in a working mode of the three-phase machine, generating a torque on a rotor by the three alternating currents; and
initiating a heating mode of the three-phase machine, in which the three alternating currents generate an increased power loss in comparison with the working mode due to a more rapid polarity change in at least one of the three alternating currents.
